(19) United States
(12) Patent Application Publication
(10) Pub. No.: US 2005/0091984 A1
(43) Pub. Date: May 5, 2005

(54) Heat shield for gas turbine engine

(76) Inventor: Robert Czachor, Cincinnati, OH (US)

Correspondence Address: Gregory A. Welte, 806 North County Road 700 West, Frankfort, IN, 46041, US

(21) Appl. No.: 10/700,185

(22) Filed: Nov. 3, 2003

(51) Int. Cl. F02C 7/24

(52) U.S. Cl. 60/772; 60/805

(57) ABSTRACT

A heat shield for a turbine shroud in a gas turbine engine. The heat shield takes the form of an annular U-shaped shell, with the open part of the U facing radially inward. The shell covers an annular flange, or other body, and is mounted to that body, or an associated body. Pleats, bellows, convolutions, or other deformations in the shell reduce the axial modulus of elasticity of the shell. Thus, thermal expansion and contraction of the shell apply reduced forces to the body to which the shell is mounted.

### TECHNICAL FIELD

The invention concerns a heat shield for a turbine casing in a gas turbine engine.

### BACKGROUND OF THE INVENTION

FIG. 1 is a schematic cross-sectional view of a gas turbine engine. Turbine 3 is surrounded by a shroud 6. FIG. 2 is a simplified perspective view of the shroud 6. FIG. 3 is a cross-sectional view, in the direction of arrows 3-3 in FIG. 2.

Each part 6A and 6B of the shroud 6 in FIG. 3 contains an annular flange 9A and 9B. Holes 12 extend through the flanges, as also indicated in FIG. 4, and the parts 6A and 6B in FIGS. 3 and 4 are assembled together by bolts (not shown).

In some designs, a heat shield 18 in FIG. 5, shown in partial exploded form, surrounds the flanges 9A and 9B, to control temperature attained by the flanges 9A and 9B. Some features of the heat shield 18 will be explained.

In many instances, the heat shield 18 is constructed in segments, as in FIG. 5. This segmentation can cause the problem illustrated in FIG. 6, which shows the segmented heat shield 18 alone, without the shroud 6. Hot or cold air, indicated by dashed arrow 21, can penetrate the joint between adjacent segments 18A and 18B.

In addition, the assembled combination the heat shield and the shroud can act as a bi-metallic thermal element, as will be explained with reference to FIGS. 7-9. FIG. 7 shows a segment 18A of the heat shield, and part of the shroud 6, which bears part of the flange 9.

FIGS. 8 and 9 show the segment 18A of the heat shield connected to the flange 9. Circles 25 represent bolts, which attach the segment 18A to the flange 9.

If the segment 18A is hotter than the shroud/flange assembly, the system will bend into the phantom shape 27 indicated in FIG. 8.

Conversely, if the segment 18A is cooler than the shroud/flange assembly, the system will bend into the phantom shape 30 indicated in FIG. 9.

The deformations of FIGS. 8 and 9, and the leakage of FIG. 6, are not desirable in many situations. The deformations can increase clearances between the rotating and static components, which is not desirable. For example, if the space between the outer tip of a turbine blade and the shroud surrounding the blade increases, then additional leakage occurs, which causes a penalty in efficiency.

### SUMMARY OF THE INVENTION

In one form of the invention, an annular hollow heat shield surrounds an annular flange in a turbine shroud in a gas turbine engine. Deformations in the walls of the heat shield allow the heat shield to change in circumference in response to changes in temperature, without applying significant force to the shroud. The deformations can take the form of convolutions, pleats, bellows, and the like.

### BRIEF DESCRIPTION OF THE DRAWINGS

FIG. 1 illustrates a schematic cross-sectional view of a gas turbine engine.

FIG. 2 illustrates a schematic view of the turbine shroud 6 of FIG. 1.

FIG. 3 illustrates a cross-sectional view of the shroud 6 of FIG. 2, taken in the direction of arrows 3-3.

FIG. 4 illustrates bolt holes 12 formed in flanges of the shroud 6.

FIG. 5 illustrates a heat shield commonly used to protect the flanges 9A and 9B.

FIG. 6 illustrates infiltration of air 21 at the junction between adjacent sections 18A and 18B of the heat shield.

FIG. 7 illustrates an exploded view of a segment 18A of a heat shield and part of the shroud 6.

FIGS. 8 and 9 illustrate two types of deformation which can occur when the heat shield 18A and the shroud 6 reach different temperatures.

FIGS. 10-12 illustrate one form of the invention.

FIG. 13 illustrates an insulating blanket 65, provided by one form of the invention.

FIG. 14 illustrates a circular array of shells 50 and 51, surrounding a shroud 40.

FIG. 15 illustrates an assembly of shells 50 and 51 in their normal state.

FIG. 16 illustrates an assembly of shells 50 and 51 in an expanded state.

FIG. 17 illustrates an assembly of shells 50 and 51 in a compressed state.

FIG. 18 illustrates another form of the invention.

FIGS. 19 and 22 illustrate other forms of the invention.

FIG. 20 illustrates schematically the apparatus of FIG. 14 installed in a gas turbine engine 100.

FIG. 21 illustrates one approach to sealing adjacent sectors of a heat shield.

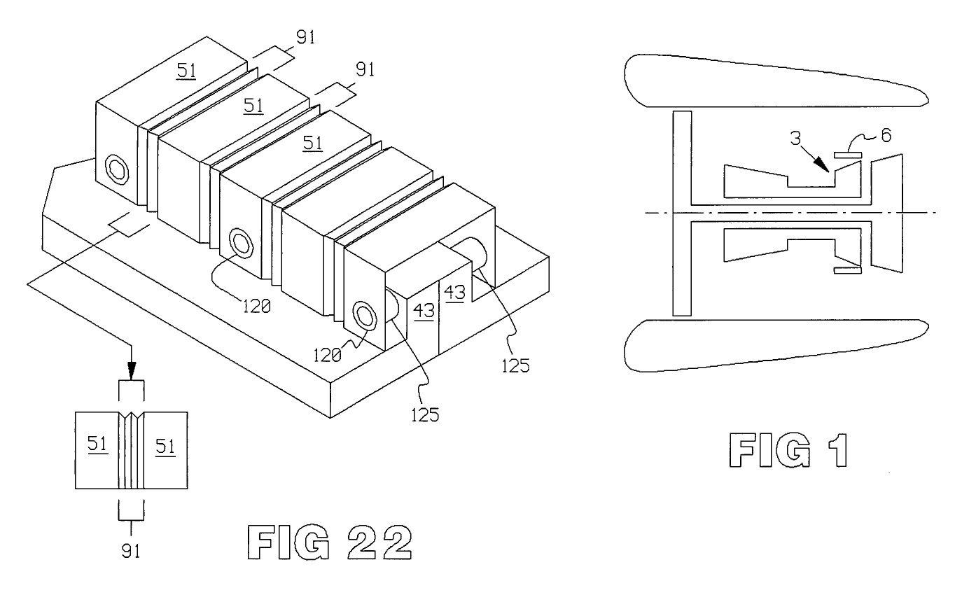

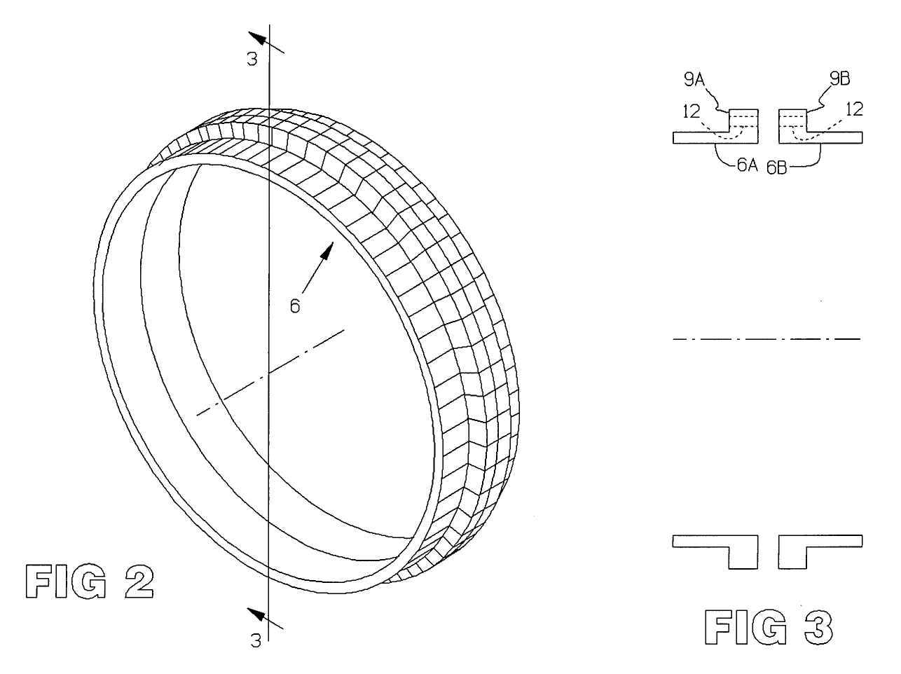

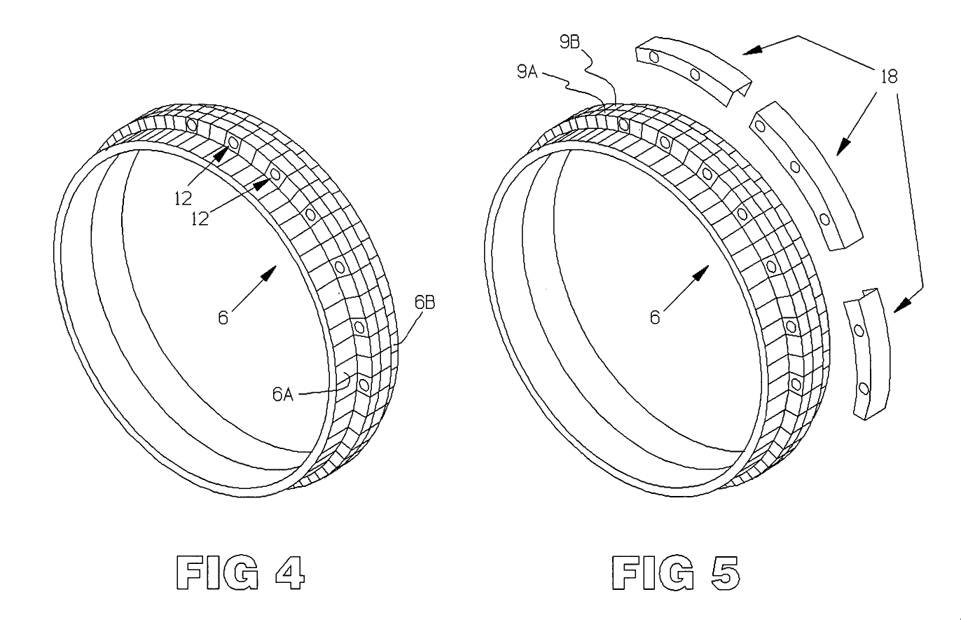

### DETAILED DESCRIPTION OF THE INVENTION

For ease of explanation, one type of heat shield embodied by the invention will be constructed conceptually in stepwise fashion. The sequence of construction of an actual heat shield will not necessarily correspond to the conceptual steps discussed.

FIG. 10 illustrates a two-part turbine shroud 40, having flanges 43. Bolt holes 45 will contain bolts (not shown) which hold the flanges 43 together. For simplicity, the shroud 40 is shown as linear, although, in practice, it will assume the shape of a hoop, with flanges 43 on the radially outer side.

Channels, or housings, 50 and 51 represent the heat shield, and are constructed of known heat-shield material. Two types of channel are present: channel 50, which is smaller, and channel 51, which is larger.

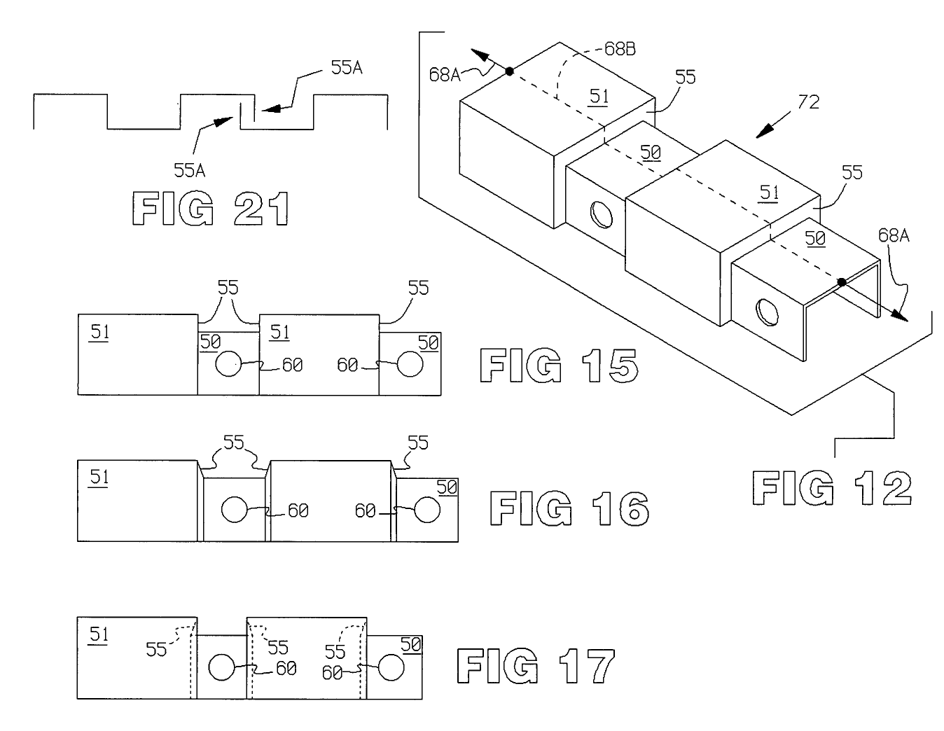

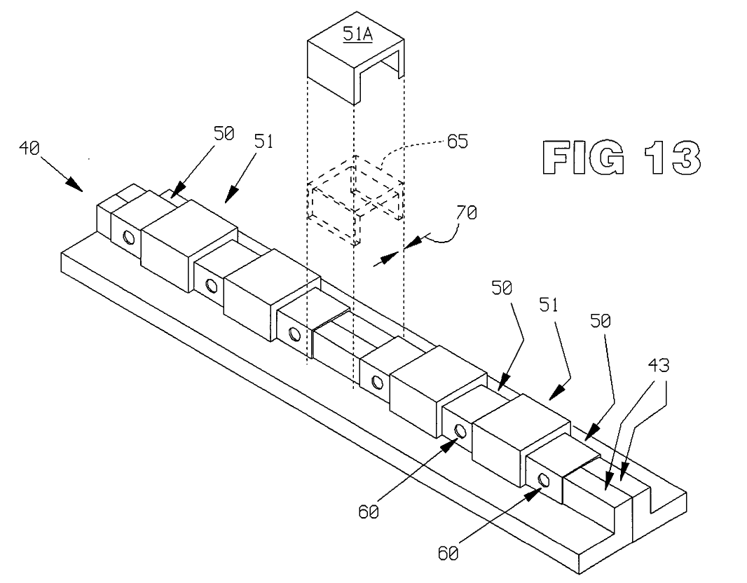

FIG. 11 shows the channels 50 and 51 positioned next to each other. FIG. 12 shows bulkheads 55 added to the ends of the larger channels 51. FIG. 13 shows a larger number of channels 50 and 51, positioned on the flanges 43.

FIG. 14 shows the channels 50 and 51, and the shroud 40, in their actual circular configurations. Outer surfaces 57 are shown as arcuate, but they may be flat. That is, the individual channels 50 and 51 may be box-like, with flat sides.

The heat-shield channels 50 and 51 form a circular array surrounding the flanges 43. This arrangement provides several advantageous features, some of which will now be explained.

As shown in FIG. 15, the smaller channels 50 contain holes 60. Bolts, not shown, extend through the holes 60 to connect the smaller channels 50 to the flanges 43 in FIG. 10. When connected, the smaller channels 50 are in good thermal contact with the flanges 43 in FIG. 10. From another perspective, the inner surfaces 63 in FIG. 10 of the smaller channels 50 are in physical contact with the flanges 43.

In another embodiment, the inner surfaces 63 are not in thermal contact with the flanges 43, but are separated from the flanges 43, as by an intervening layer of material (not shown). In yet another embodiment, bushings 125 in FIG. 22 are placed around the bolts, to separate the inner surfaces 63 in FIG. 10 from the flanges 43, although the bushings themselves do contact the flanges 43. In this latter embodiment, an air space is created between the inner surfaces 63 and the flanges 43, except at the bushings.

The larger channels 51 in FIG. 13 are separated from the flanges 43. Both channels 50 and 51 together encapsulate the flanges 43. The larger channels 51 cooperate with the flanges 43 to define an air space, or blanket, 65 adjacent the flanges 43, as indicated by exploded channel 51A. Preferably, this blanket 65 is at least one millimeter in thickness, represented by dimension 70. One specific thickness contemplated is 12 millimeters, or about 1/2 inch. The invention specifically covers all thickness between one millimeter and 60 millimeters, as well as larger thicknesses.

The question of thickness of blanket 65 can be viewed from another perspective. In general, when two flat materials are placed into contact, such as two flat pieces of glass, some air molecules generally remain between the two materials. Those air molecules could be termed a “blanket.” But, in this glass-example, some atoms of one material (one glass sheet) are nevertheless in contact with atoms of the other material (the other glass sheet).

This contact may be illustrated by common sandpaper. If the rough sides of two sheets of sandpaper are placed together, then the tips of sand grains of one sheet will contact either the sand grains or the paper of the other sheet. Air will surround the sand grains, and could be termed a “blanket.”

At the microscopic level, the sheets of glass resemble the sheets of sandpaper.

However, in one form of the invention, this type of contact is preferably not present inside larger channels 51. Blanket 65 completely separates the channel 51 from the flanges 43, except possibly at bulkheads 55 in FIG. 12. No atoms of the flange 43 extend through the blanket 65 and contact the inner surface of the channel 51, except possibly at the bulkheads 55.

Since the blanket 65 in FIG. 13 is constructed of air, which is a very good insulator, the heat-shielding properties of the channel 51 are enhanced by the blanket 65.

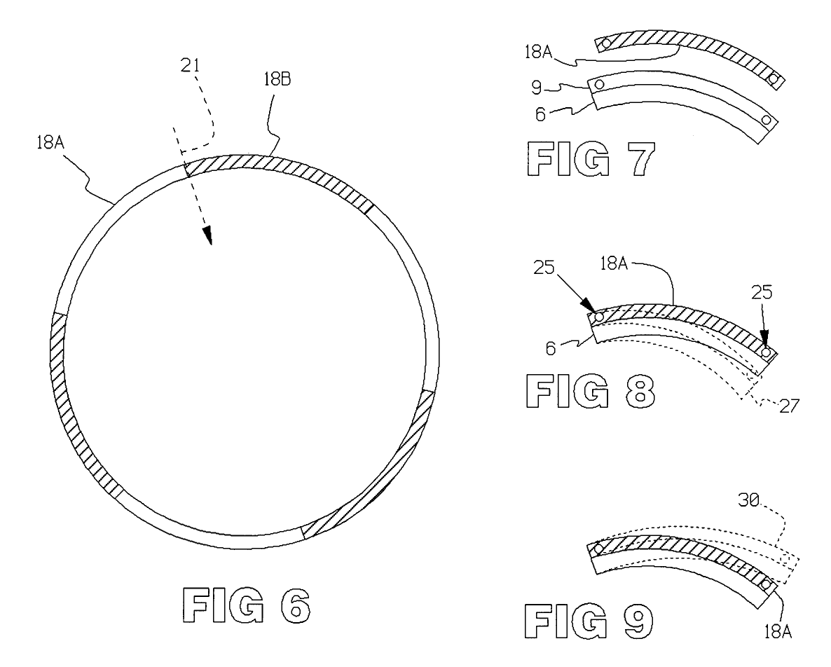

Another advantageous feature resides in a physical characteristic of bulkheads 55 in FIG. 12. The bulkheads 55 act as flexible diaphragms. They remove, or reduce, the deformations illustrated in FIGS. 7-9.

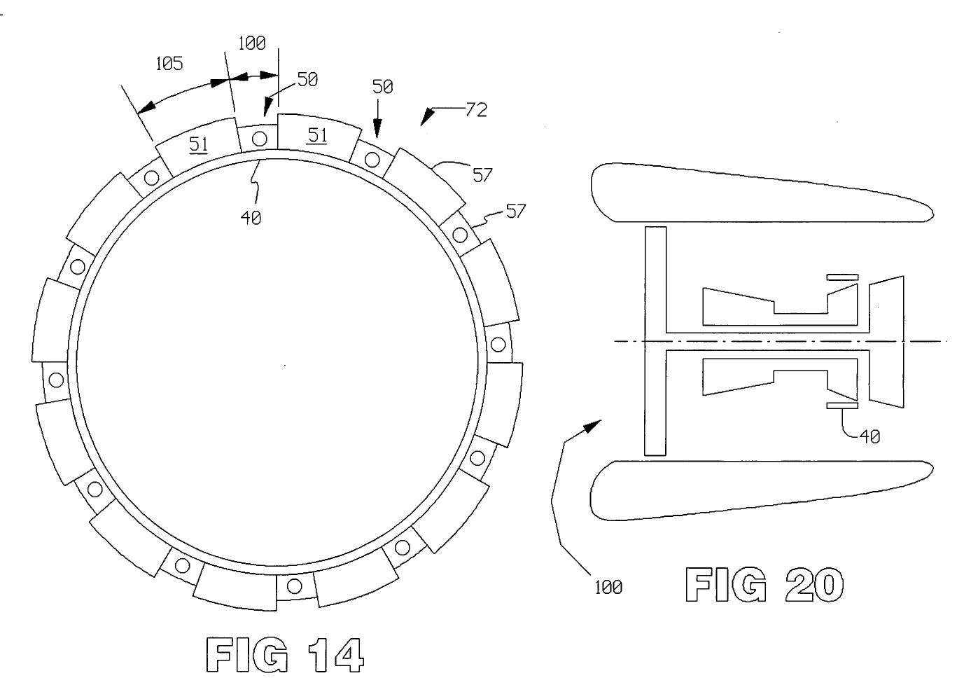

For example, FIG. 15 illustrates the bulkheads 55 in their undeformed state. If the turbine shroud (not shown) should undergo thermal expansion, relative to the channels 50 and 51, then bulkheads 55 bow outward, as indicated in FIG. 16. The overall length of the assembly of channels 50 and 51 increases.

Conversely, if the turbine shroud (not shown) should undergo thermal contraction, the bulkheads 55 bow inward, as in FIG. 17. The overall length of the assembly of channels 50 and 51 decreases.

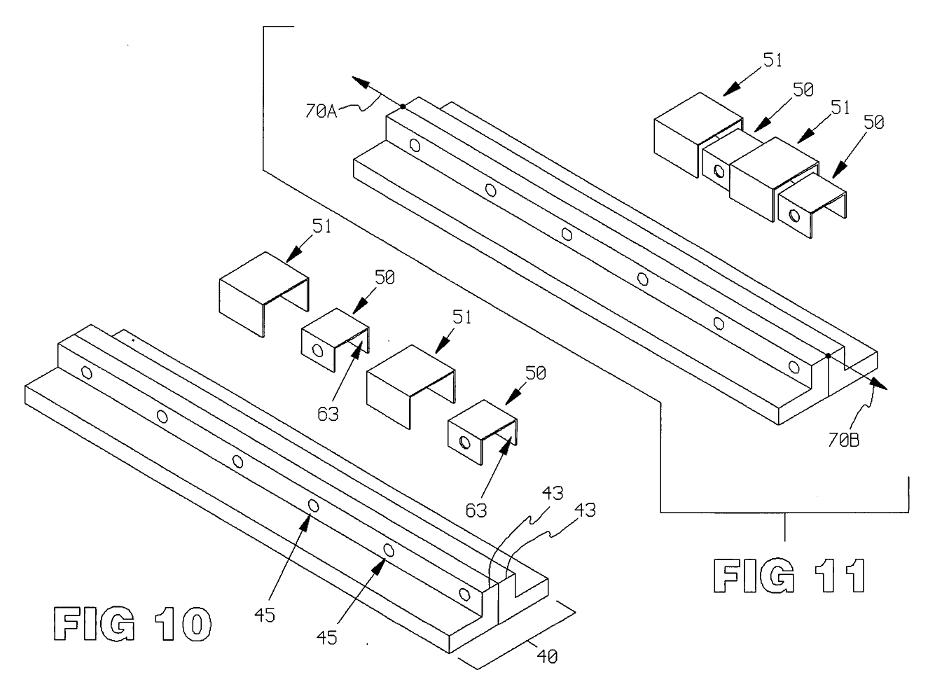

Thus, the bulkheads 55 allow an accordion-style, or bellows-style, expansion and contraction of the assembled channels 50 and 51. This expansion and contraction reduces, or eliminates, the deformations illustrated in FIGS. 8 and 9.

A numerical value for the reduction of deformation will be given for one embodiment. The heat shield 72 in FIG. 12 is a shell-like structure. It is hollow. The modulus of elasticity of the overall shell-like structure is determined by the material, and geometry, of the walls of the structure.

This modulus of elasticity of the shell-structure (as opposed to the modulus of elasticity of the material itself of which the shell-structure is constructed) is less than fifty percent, and preferably ten percent, of the modulus of elasticity of the overall shroud 40 of FIG. 10. An example will illustrate the significance of this percentage.

Assume that a pair of forces 70A and 70B are applied to the shroud 40 in FIG. 11. Assume that those forces cause a percentage elongation (ie, strain) of 0.01 percent. If the same strain (ie, percentage elongation) is to be attained in the heat shield 72 in FIG. 12, then pair of forces 68A and 68B are required. Those forces 68A and 68B must be about ten percent of the forces 70A and 70B in FIG. 11, which is the percentage given in the preceding paragraph.

Stating this another way, assume that the moduli of elasticity of shroud 6 in FIG. 8 is equal to that of the shell-like heat shield 18A. A given deformation occurs at a given temperature difference between the shroud 6 and the shield 18A. However, if the modulus of the shield 18A is ten percent of that of the shroud 6, as stated above, then the deformation will, roughly, be about that same percentage, namely ten percent, of the deformation occurring when the moduli are equal.

The large discrepancy in size between the forces 68A and 68B in FIG. 12 and forces 70A and 70B in FIG. 11 is taken to indicate that the deformation of the type shown in FIGS. 8 and 9 is effectively eliminated, or substantially reduced.

The modulus of elasticity under consideration, which is found based on forces 68A and 68B in FIG. 12, will be termed an axial modulus of elasticity. One reason is that the elongation, or contraction, of the heat shield 72 which occurs in response to the forces does so in the direction of the longitudinal axis of the heat shield 72. Of course, the heat shield 72 is an annular structure. Nevertheless, short sections can be viewed as linear, and having a longitudinal axis. This concept of axial modulus also applies to the shroud 40 in FIG. 14.

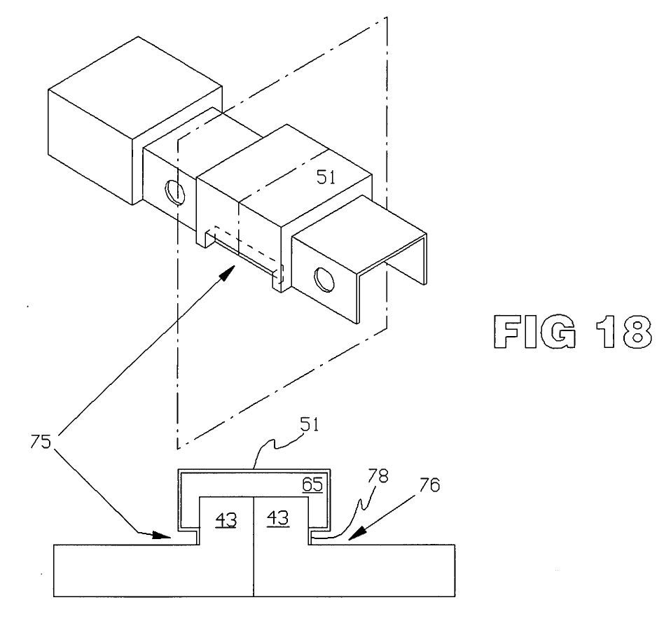

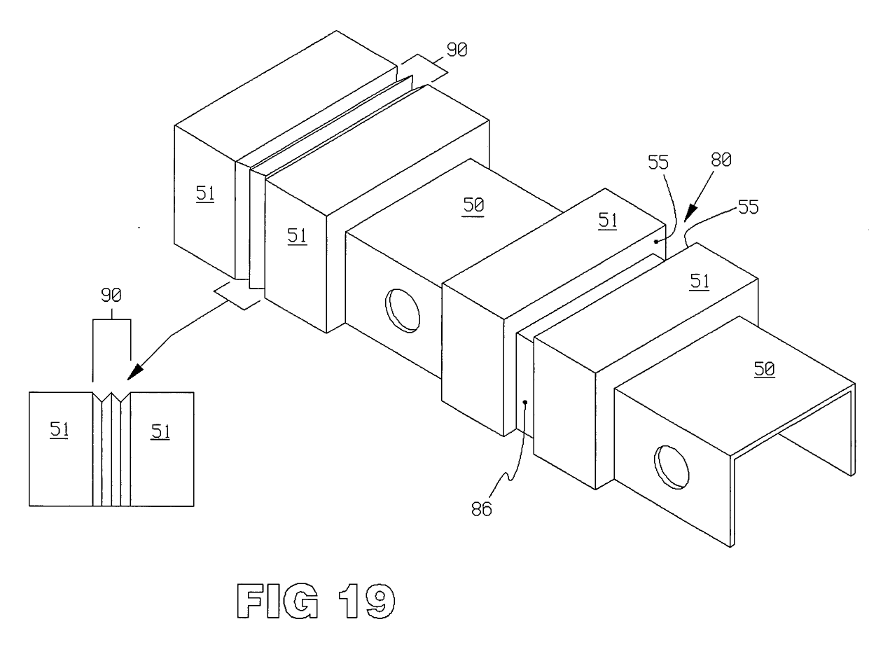

FIG. 18 illustrates another form of the invention. The larger channels 51 can be equipped with depressions 75, which mate with the flanges 43, and act as air seals. Stated in other words, the base 76 of shell 51 is equipped with a flange 78 which engages flange 43, to form a seal.

FIG. 19 illustrates another form of the invention, wherein a U-shaped channel 80 is formed in some, or all, of the larger shells 51. Each U-shaped channel 80 adds two additional bulkheads, or diaphragms, 55. The added diaphragms 55 provide additional flexibility.

The inner surface of the base 86 of the U-shaped channel 80 may, or may not, contact the flanges 43 (not shown in FIG. 19). In addition, a true bellows may be formed in some, or all, of the larger channels 51, as indicated by bellows 90.

FIG. 22 illustrates an other form of the invention. All sections 51 are of the same cross-sectional size and shape. Adjacent sections 51 are connected by pleats, bellows, or deformations, such as those shown in FIG. 19, and indicated as elements 91 in FIG. 21. Periodic bolt holes 120 are provided, and bushings 125 space sections 51 from the flanges 43.

Some significant features of the invention include the following. One is that the heat shield 72 in FIG. 14 is a continuous structure, at least in the sense of being impervious to air flow, except possibly at the locations where the heat shield contacts the shroud, namely, at region 76 in FIG. 18. That is, unlike the prior-art situation of FIG. 6, no leakage exists at junctions between adjacent channels 50 and 51.

The heat shield 72 may be constructed in two halves, defined by the split line 68B in FIG. 12. The two halves are mirror images of each other. The single split line, or seam, is less than the number of seams found in the prior art. Thus, opportunities for leakage through the single split line 68B is less than in the multiple seams in the prior art.

A second feature is that the heat shield 72 in FIG. 14 can be viewed as constructed of two types of units. One unit 50 spans a first sector 100 of the shroud 40, and acts as a mounting unit. This unit is U-shaped, with at least the legs of the U in thermal contact with the flanges 43 of FIG. 13. A second unit 51 in FIG. 14 spans a second sector 105 of the shroud 40, and contains the blanket 65 of FIG. 13. The two units are sealed to each other by bulkheads 55 in FIG. 12.

A third is that the heat shield 72 in FIG. 14 can be viewed as containing an array of housings 51, between which are interleaved brackets 50. The housings 51 and brackets 50 are connected to each other, through bulkheads 55 in FIG. 12 which act as gas seals. The brackets 50 connect the assembly to the flanges 43 in FIG. 13.

A fourth feature is that the heat shield 72 in FIG. 14 can be constructed in sectors. The structure shown in FIG. 12 can represent one sector, though linearized in depiction. Adjacent sectors are sealed to each other, as by overlapping bulkheads 55A, as in FIG. 21. Such seals are known in the arts of sheet-metal working, particularly as applied to metal roofing and heating duct work.

In the case of FIG. 21, it is possible that the axial modulus of elasticity is only defined in tension, and not in compression, if the joint, or seal, used does not resist compression.

An axial modulus of elasticity of less than fifty percent, and preferably ten percent, for the heat shield was discussed above. Different embodiments can utilize all percentages from one to fifty, respectively.

Numerous substitutions and modifications can be undertaken without departing from the true spirit and scope of the invention. What is desired to be secured by Letters Patent is the invention as defined in the following claims.

1. A system, comprising:
a) a gas turbine engine, which includes at least one annular flange extending from a turbine casing; and
b) a continuous annular heat shield, which
i) encapsulates the annular flange, and
ii) includes bellows or diaphragms which reduce the axial modulus of elasticity of the heat shield.

2. System according to claim 1, wherein the annular heat shield includes base edges adjacent the turbine casing, and the annular heat shield is impervious to gas flow, except possibly at the base edges.

3. System according to claim 1, wherein the annular heat shield is constructed of several adjacent units, each unit including
c) a mounting section in thermal contact with a first sector of the flange;
b) a hollow section surrounding a second sector of the flange, and separated from the second sector by a blanket of air; and
d) a bulkhead lying in an axial plane, which connects the bracket section with the hollow section.

4. System according to claim 3, wherein the mounting sections are generally U-shaped in cross section, with legs of the U in thermal contact with the annular flange.

5. System according to claim 3, wherein the bulkheads flex during thermal expansion or contraction of the annular heat shield.

6. System according to claim 1, and further comprising spacers which extend between the heat shield and either the annular flange or the turbine casing, and which support the annular flange.

7. A system, comprising:
a) a gas turbine engine, which includes an annular flange extending from a turbine casing, the flange/casing having an axial modulus of elasticity defined therein; and
b) a heat shield, which
i) encapsulates a sector of the flange, and
ii) has an axial modulus of elasticity which is less than fifty percent of the axial modulus of elasticity of the sector.

8. Method of operating a gas turbine engine, comprising:
a) maintaining an annular body on an outer surface of a turbine casing;
b) maintaining an array of housings, each
i) encapsulating a respective sector of the annular body, and
ii) maintaining a blanket of air adjacent said respective sector;
c) maintaining an array of brackets, each
i) between a pair of housings; and
ii) in thermal contact with a respective sector of the body;
d) maintaining a gas seal between each bracket and its adjacent pair of housings.

9. Method according to claim 8, and further comprising:
e) maintaining bolts which extend through the annular body, each bolt fastening a bracket to the annular body.

10. Method according to claim 8, wherein the brackets, housings, and seals present a spatially continuous barrier to gases moving toward the annular body, except possibly at the radially innermost parts of the brackets, housings, and seals.

11. A system, comprising:
a) a gas turbine engine, which includes at least one flange extending from a turbine shroud;
b) an annular heat shield constructed of a sequence of hollow units, each unit surrounding a sector of the flange, and each unit comprising:
i) a first housing which surrounds a first sector of the flange, and
ii) a second housing which surrounds a second sector of the flange to define an air space between the second housing with the second sector.

12. System according to claim 11, wherein (A) the first housing is generally U-shaped in cross-section, and (B) legs of the U straddle the flange.

13. System according to claim 11, and further comprising bolts which extend through the first housings and through the flange, and which clamp the first housings into thermal contact with the flange.

14. System according to claim 11, and further comprising
c) a planar diaphragm, lying in an axial plane, connecting an end of the first housing with an end of the second housing.

15. System according to claim 11, and further comprising:
c) bellows means within the heat shield for reducing the axial modulus of elasticity of the heat shield.

16. System according to claim 11, and further comprising a collection of spacers positioned between the annular heat shield and either the annular shroud or the flange, which spacers support the annular heat shield.

17. System according to claim 16, wherein an annular space exists between the annular heat (shield and the flange.

18. A system, comprising:
a) a gas turbine engine containing a turbine shroud from which extends an annular body;
b) an annular heat shield encapsulating the annular body, comprising:
i) shell sections;
ii) deformable connectors between adjacent shell sections; and
iii) connectors for connecting the shell sections to the shroud or annular body,
wherein each shell section captures a blanket of air adjacent the annular body.

19. System according to claim 18, wherein the connectors are U-shaped, and of smaller cross-section than the shell sections.
